(19) United States
(12) Patent Application Publication
(10) Pub. No.: US 2017/0352980 A1
(43) Pub. Date: Dec. 7, 2017

(54) SPRING LOADED TERMINAL FOR CONDUCTORS

(71) Applicant: Weidmüller Interface GmbH & Co. KG, Detmold (DE)

(72) Inventor: Peter Stuckmann, Lage (DE)

(21) Appl. No.: 15/604,861

(22) Filed: May 25, 2017

(30) Foreign Application Priority Data
Jun. 2, 2016 (DE) 202016102959.7

(51) Int. Cl. H01R 13/627; H01R 25/00; H01R 13/24

(52) U.S. Cl. CPC H01R 13/6272; H01R 13/2428; H01R 25/003

(57) ABSTRACT

A spring loaded direct plug-in terminal with a direct plug-in connector for the connection of a conductor includes a housing with a chamber and a plug-in channel for plugging the conductor into the chamber. The terminal also includes a busbar, a clamping spring arranged in the chamber and acting as a compression spring for fixing the electrical conductor on the busbar in the area of a clamping site. The clamping spring includes a pivotable clamping arm which can be adjusted from a locked state in a locked position into a clamping state in which it is unlocked from the locked state and presses the electrical conductor against the busbar. An actuation element which is movable in the housing is provided which, together with the clamping arm of the clamping spring, can be locked in the locked state. The mobility of the actuation element in the housing in the locked state can be arrested by a locking element which is movable at an angle relative to the movement direction of the actuation element.

This application claims priority of German patent application No. DE 202016102959.7 filed Jun. 2, 2016 which is incorporated herein by reference.

### BACKGROUND OF THE INVENTION

The present invention relates to a spring loaded terminal.

Spring loaded terminals in the form of direct plug-in or push-in terminals with a clamping spring designed as a compression spring which presses a conductor against a busbar are known in the prior art. They differ based on the use thereof as a function of the needed current carrying capacity of the busbar, on the spring force of the clamping spring and/or on the installation conditions and on the size thereof. Simple installation and cost effective manufacture are requirements that are always applicable to such terminals.

U.S. Pat. No. 7,997,915 B2 discloses a connector on the end of which that faces away from the pin terminal is arranged a direct plug-in terminal for the non-detachable connection of an electrical conductor. The direct plug-in terminal includes a current carrying clamping cage for electrical contact with the electrical conductor and a spring for the electrical conductor. The spring has a pivotable clamping arm which, when an electrical conductor is not introduced into the direct plug-in terminal, is positioned on a holding edge of a holding spring, so that a free space is kept clear for the electrical conductor so that the conductor can be introduced into the clamping cage. When the direct plug-in terminal is introduced, an arm of the holding spring is shifted in such a manner that the clamping arm is released and is pivoted. The pivoted clamping arm presses the electrical conductor against the clamping cage.

### SUMMARY OF THE INVENTION

The present invention was developed to produce a spring loaded terminal, in particular a stackable spring loaded terminal for stranded conductors, which improves this functionality and which is also usable for stranded conductors with a small cross section.

A spring loaded terminal—designed in particular in the form of a direct plug-in terminal with a direct plug-in connector—is produced for connection of a conductor which can be designed as a flexible stranded conductor. The terminal includes a housing with a chamber and a plug-in channel for plugging the conductor into the chamber, a busbar, and a clamping spring which is arranged in the chamber and acts as compression spring for fixing the electrical conductor on the busbar in the area of a clamping site. The clamping spring includes a pivotable clamping arm which can be adjusted from a locked state in which it is locked in a locked position into a clamping state in which it is unlocked from the locked state and presses the electrical conductor against the busbar. An actuation element which is movable in the housing is provided and which together with the clamping arm of the clamping spring can be locked in the locked state. Movement of the actuation element in the housing in the locked state can be barred by a locking element that can be moved at an angle relative to the movement direction of the actuation element. In this manner, not only is the clamping spring locked but so is the actuation element. This makes it possible to arrange the locking element in the housing and accessible outside of the housing in such a manner that it is easy to reach directly by hand and/or with a tool such as a screwdriver in order to release the locking element from the locked position. A manual release includes a corresponding contour that can be gripped manually, such as a protrusion on the locking element, is manually accessible from outside.

A metal spring which directly latches or locks a free end of the clamping arm such as in the prior art devices is thus unnecessary. In this manner, damage to the clamping arm is also prevented.

Preferably, the actuation element is designed in a structurally simple manner as a actuation device for moving the clamping arm which is movable in an actuation channel of the housing in the plug-in direction. Movement of the clamping arm in the actuation channel can be locked and released by moving the locking element at an oblique angle relative to the actuation channel. In this manner, the invention can be implemented in a simple and reliable manner.

According to a preferred embodiment, the locking element includes a spring element. In this manner, the locking element can automatically be moved by the spring action into a latching position or locking position in which it prevents movement of the actuation device and results in the locked position of the clamping arm. This spring element in turn is designed to move the locking element in a locking channel at an oblique angle into the actuation channel.

Preferably, the spring element is designed in such a manner that a spring force can be generated under which the head automatically can be pulled or shifted from the locking channel into the actuation channel when the actuation device is pushed down sufficiently into the actuation channel that the head of the locking element can move into the actuation channel. In this manner, the handling of the spring loaded connector is relatively simple.

The locking element can be moved back manually preferably by an actuation tool such as a screwdriver in the locking channel at an angle relative to the conductor plug-in direction, so that the actuation device is released which in turn releases the clamping arm of the clamping spring so that the clamping arm is released from the locked position and is relaxed. For this purpose, the locking element includes an actuation contour on which a tool can be set.

The spring loaded terminal is suitable not only for solid wires, but also for stranded conductors. A stranded conductor can be moved back and forth without splaying of the strands in the locked state in the free space of the chamber in the housing. It is possible to select a material for the busbar which has good electrical conductivity, for example, copper or a copper alloy. For the clamping spring, steel is a suitable manufacturing material.

In this manner, it is possible to produce a pin or socket strip with several stacked spring loaded terminals. However, with one or more of such spring loaded terminals, it is also possible to produce terminal blocks. In addition, the spring loaded terminal can also be used in other types of housings.

### BRIEF DESCRIPTION OF THE FIGURES

Other objects and advantages of the invention will become apparent from a study of the following description when viewed in the light of the accompanying drawing, in which:

FIG. 1a is a cross-sectional view of a spring loaded terminal with a clamping arm for clamping an electrical conductor which is introduced into the spring loaded terminal in a non-locked state of a clamping arm;

FIG. 1b is a cross-sectional view of the spring loaded terminal from FIG. 1a with the clamping arm in the locked state;

FIG. 1c is a cross-sectional view of the spring loaded terminal from FIG. 1b with a conductor introduced into an area of a clamping site during release of the locked state of the clamping arm;

FIG. 1d is a cross-sectional view of the spring loaded terminal from FIG. 1c with the clamping arm released from the locked state in contact with the conductor;

FIG. 1e is a cross-sectional view of the spring loaded terminal from FIG. 1d during opening of the clamping site by pushing down an actuation element in the form of a actuation device;

FIG. 1f is a cross-sectional view of the spring loaded terminal from FIG. 1e after the opening of the clamping site by pushing down of the actuation device during the removal of the conductor from the clamping site;

FIG. 2a is a perspective view of a section of a spring loaded terminal of the type of FIG. 1 with a clamping arm in the locked state without a busbar being shown;

FIG. 2b is a perspective view of the spring loaded terminal from FIG. 2a after releasing the locked state of the clamping arm without a conductor being shown; and

FIG. 3 is an exploded perspective view of a connection strip with several spring loaded terminals.

### DETAILED DESCRIPTION

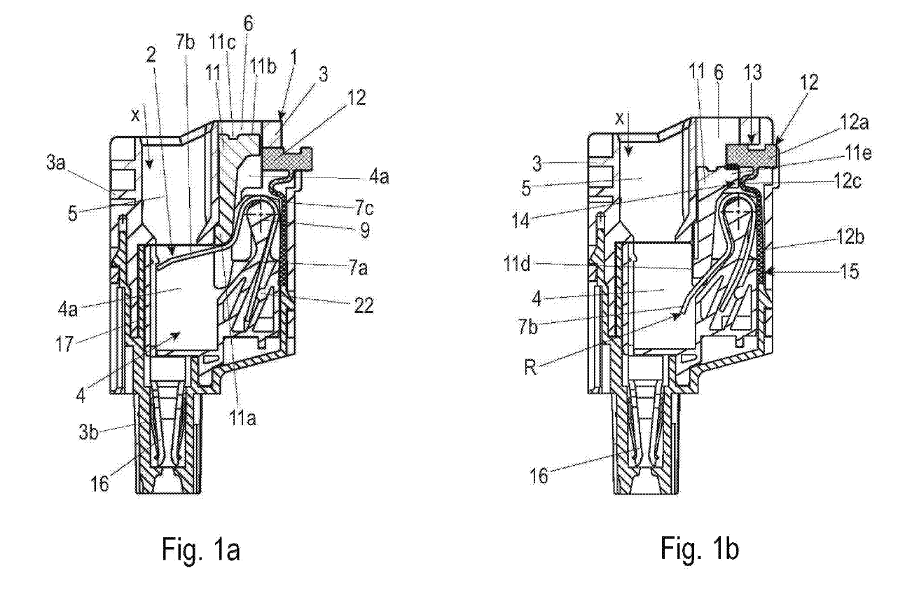

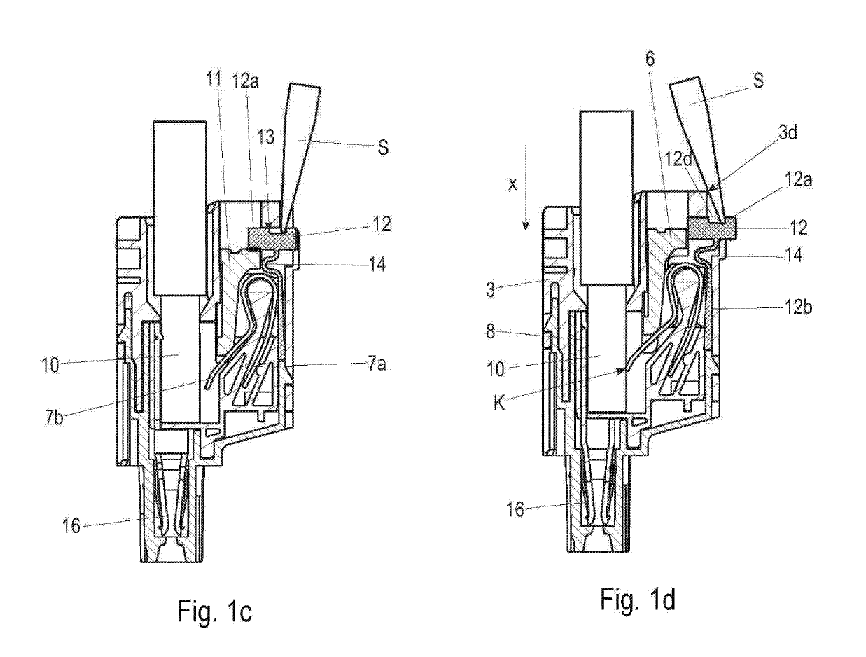

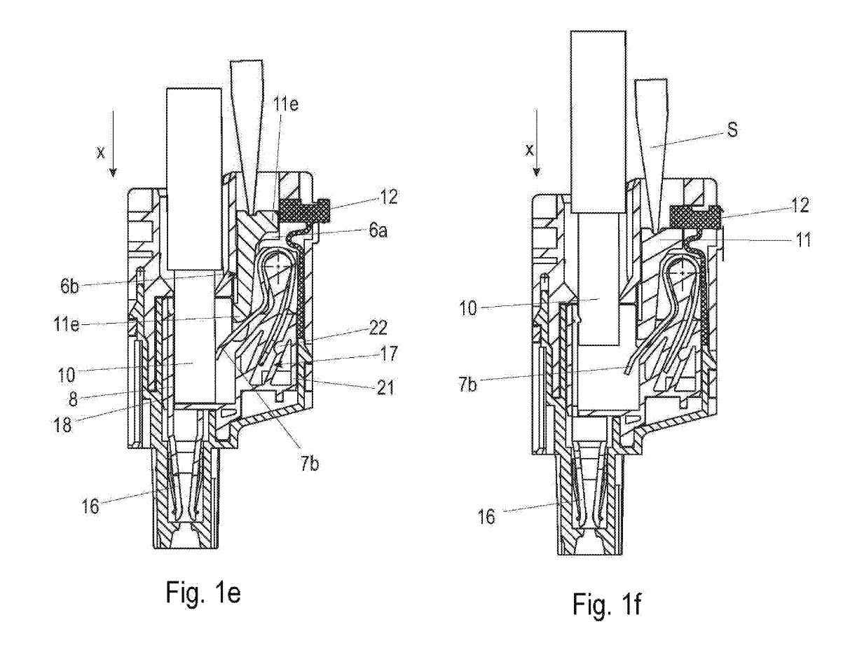

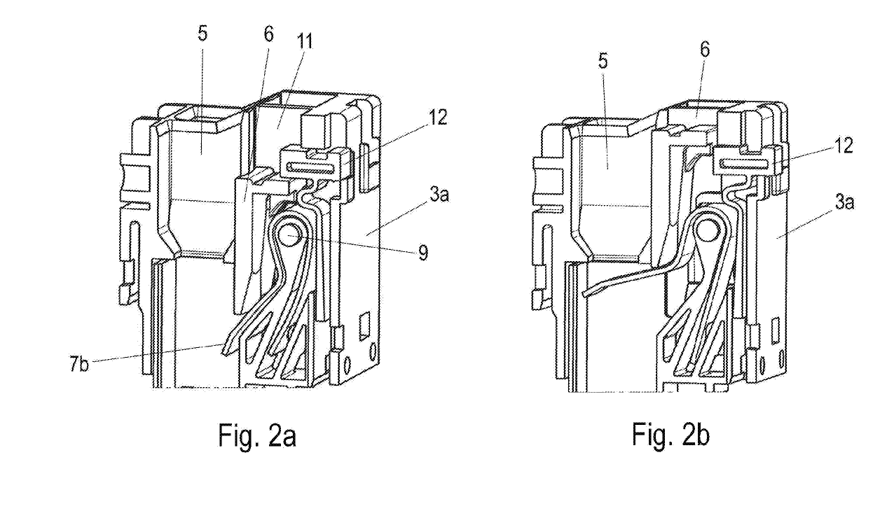

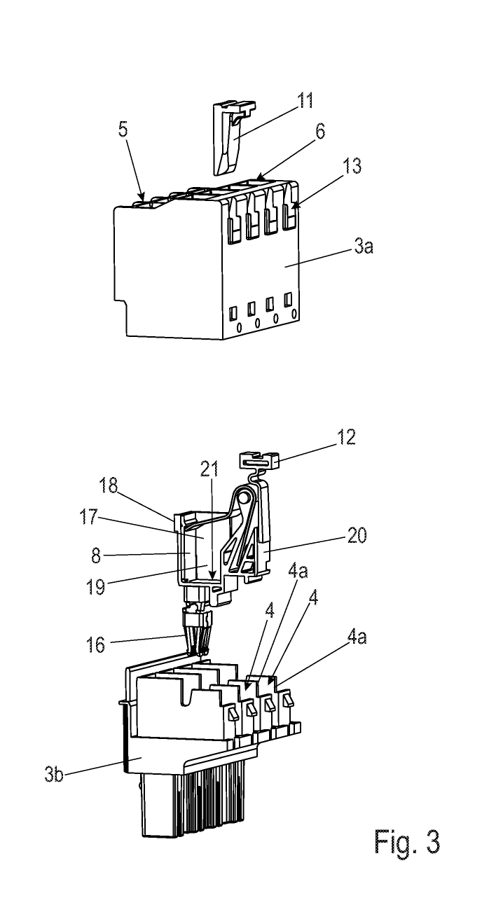

FIG. 1 and FIG. 2 each show a respective spring loaded terminal 1 of identical design with a direct plug-in connector 2 which is arranged in a single-part or preferably a multi-part housing 3. The spring loaded terminal 1 is shown in each case in a stackable design. This means that perpendicularly to the image plane in one or more housings 3, one or more of the direct plug-in connectors 2 can be formed one after the other, for example, in the manner of a multipolar connection strip such as shown in FIG. 3.

The single-part or multi-part housing 3 are formed of an insulating plastic. The housing 3 has a housing upper portion 3a and a housing lower portion 3b which are locked together.

In the housing lower portion 3b, a chamber 4 or several chambers 4 are formed.

As shown in FIG. 3, the chambers 4 are separated from one another by a respective wall 4a. In the multipolar design, several chambers 4 are formed one after the other in the housing 3 perpendicularly to the image plane of FIG. 1a, in each of which one of the direct plug-in connectors 2 is formed.

The chamber 4 is connected by a conductor plug-in channel 5 to one of the outside surfaces of the housing—referred to as “plug-in side”- and by an actuation channel 6. The conductor plug-in channel 5 and the actuation channel 6 are formed in the housing upper portion 3a. The actuation channel 6 extends substantially parallel to the conductor plug-in channel 5. The actuation channel 6 is stepped as shown in FIG. 1a.

In the chamber 4, for the formation of the direct plug-in connector 2, at least one clamping spring 7 and a busbar 8 are arranged. Optionally, an insert 17 made of plastic or a clamping cage made of metal can be provided which is used for supporting the clamping spring 7 and the busbar 8. In a cost-effective and space-saving design, no metal clamping cage is provided, but instead the insert 17 is provided for ease of installation.

The insert 17 is inserted into the chamber 4 in the housing lower portion 3b. The insert 17 acts as a clamping cage. It is U-shaped in top view. In the downward direction, it includes a perforation 21 for inserting the busbar 8, which abuts against one of the walls 18, 19, 20 of the insert 17 which is U-shaped in a top view from above. The insert 17 is formed of non-conductive plastic.

Support of the clamping spring 7 and the busbar 8 can also be provided by walls of the chamber 4 of the housing 2 such as a terminal block which is open on one side for locking on a busbar.

It should be noted that the busbar 8 is connected to a second connector 16 or designed as a single part. This connector is designed as a spring connector in the form of a socket contact and it enables an external conductor or plug to be plugged into the housing 3. The connector can also be designed as a pin or blade connector.

The clamping spring 7 is U-shaped or V-shaped and includes a supporting arm 7a and a clamping arm 7b. The supporting arm 7a is supported against an abutment. The abutment is formed by a ridge 22 of the insert 17 as shown in FIG. 1e.

The clamping arm 7b is connected via an arched back 7c to the supporting arm 7a. The back 7c extends over a supporting contour 9 of the insert 17 which protrudes into the chamber 4. This supporting contour 9 is designed to be semi-cylindrical towards the back 7c and, moreover, it also forms an abutment for limiting the movement of the clamping arm 7b.

The clamping arm 7b is used to press the end of a conductor 10 against the busbar 8. In this manner, an electrically conductive contact is established between the conductor 10 in the area of the clamping site K as shown in FIG. 1d.

The conductor 10 is led in a conductor plug-in direction X through the conductor plug-in channel 5 into the chamber 4 in the area of the clamping site K.

In the actuation channel 6, an actuation element for moving the clamping arm 7b is arranged. The actuation element is designed in the form of a push element or actuation device 11 which is slidably led in the actuation channel 6.

The actuation device 11, with an end 11a thereof which is designed as a push contour, rests on the clamping arm 7b. By pressing against the end 11b located away from the clamping arm 7b, a force can be exerted in the plug-in direction X on the clamping arm 7b, in order to move the actuation device 11 in plug-in direction and thus also move or pivot the clamping arm 7b and in order to open the clamping site K.

The end 11b of the actuation device 11 facing away from the clamping arm 7b has an actuation contour 11c in the form of a recess or a slot for receiving a tool such as a screwdriver S as shown in FIGS. 1c and 1d.

On the ends 11a, 11b of the actuation device 11, ledges or protrusions 11d, 11e are provided, which cooperate with edges 6a, 6b or steps of the actuation channel 6 and which limit the movement of the actuation device 11 in the plug-in channel in and opposite to the plug-in direction.

A locking element 12 is associated with the actuation device 11. When the actuation device 11 is pushed down sufficiently into the actuation channel 6, the clamping site K is opened and a conductor 10 can be introduced into the clamping site and fixed by the locking element as shown in FIGS. 1a and 1b.

For this purpose, a locking channel 13 is provided in the housing upper portion at an oblique angle relative to the actuation channel 6. The locking channel leads into the actuation channel 6 and directs the locking element 12 in a sliding manner.

After the actuation device 11 is pushed downward, the locking element 12 in the locking channel 13 can be moved into a position in which the locking element 12 locks the position of the actuation device 11 and thus the lock open position of the clamping arm 7b. FIG. 2a shows in cross section a disk-shaped section of the housing upper portion 3a. FIG. 3 shows an outside view of the housing upper portion 3a.

In a preferred embodiment, this movement occurs automatically due to a spring element 14. This spring element 14 is designed to form a single piece with the locking element 12. However, a separate spring can also be associated with the locking element 12.

The locking element 12 includes a head 12a made of plastic and a spring arm 12b which is like a leaf-spring at least in sections and which is designed to form a single piece with the head. The spring arm 12b has a bend 12c and in this manner forms the spring element 14. The spring arm 12b is supported in the housing 3 in a slot 15 parallel to the supporting arm 7a of the clamping spring 7.

The spring element 14 is designed such that a spring force is generated by which the head 12a is pulled automatically in the locking channel 13 into the actuation channel 6, when the actuation device 11 in the actuation channel 6 has been pushed down sufficiently far that the head 12a of the locking element 12 can move freely into the actuation channel 6. The spring 14 engages the locking element 12 in a springy manner that, after the actuation device 11 has been pushed down sufficiently, the head 12a of the locking element 12 is moved laterally in the locking channel 13 to the point that it sinks at an oblique angle into the actuation channel 6 and prevents backward movement of the actuation device 11 against the conductor introduction direction X.

Since the locking element 12 locks the position of the actuation device 11 and thus the lock open position of the clamping arm 7b, the insulated end of the conductor 10 can now be led in the conductor plug-in direction X in the conductor introduction channel 5 into the clamping site K as shown in FIG. 1c.

The locking element 12 is also used to unlock the locked position of the actuation device 11 or of the clamping arm 7b. The locking element 12 is manually moved backwards, preferably using an actuation tool such as a screwdriver S, in the locking channel 13 perpendicularly to the conductor plug-in direction X, so that the actuation device 11 is released, which in turn releases the clamping arm 7b of the clamping spring 7, so that the latter can be relaxed. As a result, the conductor 10 is pressed against the busbar 8 and electrically contacted in the area of the clamping site K as shown in FIG. 1d. The actuation device 11 moves back in the actuation channel 6 into an upper position, in which it is located axially in front of the locking channel 13.

The locking element 12 preferably has an actuation contour 12d such as a slot on the head 12a on which a tool such as the screwdriver S can be set. The screwdriver S can thus be used as a pivotable lever arm to interact with an edge 3b of the housing 3 to move the locking element 12 laterally in the cross channel 15, so that the locked positions of the actuation device 11 and of the clamping arm 7b are released as shown in FIG. 1d. The clamping arm 7b relaxes and is moved/pivoted in direction of the clamping site K.

The housing 3 is designed so that in another channel or laterally on the housing 3, the slot 12d can be reached with the screwdriver S. The screwdriver S is arranged in the slot 12d to be able to move the locking element 12 laterally in the locking channel 13 by pivoting the screwdriver S in order to release the locked position of the actuation device 11 and of the clamping arm 7b of the clamping spring 7.

While the preferred forms and embodiments of the invention have been illustrated and described, it will be apparent to those of ordinary skill in the art that various changes and modifications may be made without deviating from the inventive concepts set forth above.

1-17. (canceled)

18. A spring loaded terminal for electrical connection with a conductor, comprising
(a) a housing containing a chamber and a plug-in channel for plugging the conductor within said chamber;
(b) a busbar arranged within said housing adjacent to said chamber;
(c) a clamping spring arranged within said chamber for connecting the conductor with said busbar within a clamping region of said chamber, said clamping spring including a clamping arm which pivots from a locked position to a clamping position in which said clamping arm biases the conductor against said busbar;
(d) an actuation device movable within said housing in a first direction for locking said clamping arm in the locked position; and
(e) a locking device movable at an angle relative to said first direction for preventing movement of said actuation device when it is in the locked position.

19. A spring loaded terminal as defined in claim 18, wherein said housing contains an actuation channel within which said actuation device moves in said first direction, said locking device being movable at an oblique angle within said actuation channel to lock said actuation device in the locked position.

20. A spring loaded terminal as defined in claim 19, where said locking device comprises a spring element.

21. A spring loaded terminal as defined in claim 20, wherein housing contains a locking channel arranged at an oblique angle relative so said actuation channel, said spring element displacing said locking device within said locking channel.

22. A spring loaded terminal as defined in claim 21, wherein said spring element displaces said locking device into said actuation channel to lock said actuation device in the locked position.

23. A spring loaded terminal as defined in claim 21, wherein said spring element is independent of said locking device.

24. A spring loaded terminal as defined in claim 21, wherein said locking device includes a head portion and a spring arm.

25. A spring loaded terminal as defined in claim 24, wherein said locking device spring arm is integral with said head portion.

26. A spring loaded terminal as defined in claim 25, wherein said housing contains a slot beneath said locking channel, said locking device spring arm being arranged in said slot, and further wherein said locking device contains a bend between said head portion and said spring arm.

27. A spring loaded terminal as defined in claim 26, wherein said locking device spring arm and bend bias said head portion toward said actuation channel, whereby when said actuation device is displaced within said actuation channel beyond said locking device head portion, said locking device head portion moves into said actuation channel to lock said actuation device in the locked position.

28. A spring loaded terminal as defined in claim 27, wherein said locking device head portion is manually displaceable within said locking channel against the bias force of the spring to release said actuation device from the locked position.

29. A spring loaded terminal as defined in claim 28, wherein said locking device head portion is configured to receive a tool to manually displace said head portion within said licking channel against the bias force.

30. A spring loaded terminal as defined in claim 19, wherein said actuation channel extends parallel to said plug-in channel.

31. A spring loaded terminal as defined in claim 18, wherein said busbar is electrically connected with a further connector for connection with at least one of a further conductor and plug.

32. A spring loaded terminal as defined in claim 18, wherein said housing chamber contains an insert for supporting said clamping spring and said busbar.

33. A spring loaded terminal as defined in claim 31, wherein said housing includes an upper portion containing said chamber, said clamping spring, said actuation device, said locking device, and said busbar and a lower portion containing said further connector.

34. A socket strip comprising a plurality of spring loaded terminals as defined in claim 18 connected in stacked relation.
